(19) United States
(12) Patent Application Publication
(10) Pub. No.: US 2014/0163738 A1
(43) Pub. Date: Jun. 12, 2014

(54) MULTI-AXIS CONTROL SYSTEM SETTING/ADJUSTMENT FUNCTION SUPPORTING APPARATUS

(71) Applicant: Kyohei Suzuki, Chiyoda-ku (JP)

(72) Inventor: Kyohei Suzuki, Chiyoda-ku (JP)

(73) Assignee: MITSUBISHI ELECTRIC CORPORATION, Chiyoda-ku, Tokyo (JP)

(21) Appl. No.: 14/000,477

(22) PCT Filed: Dec. 10, 2012
(86) PCT No.: PCT/JP12/81985

§ 371 Date: Aug. 20, 2013

(51) Int. Cl. G05B 15/02

(52) U.S. Cl. CPC G05B 15/02
USPC 700/275

(57) ABSTRACT

A multi-axis control system setting/adjustment function supporting apparatus having a setting/adjustment function through an input unit and an output unit for a multi-axis control system that includes a plurality of axes, the multi-axis control system executing a positioning control by synchronizing the plurality of axes according to a command from a motion controller, wherein the apparatus set, for a system configuration of the plurality of axes provided with respective numbers displayed in a list form on the output unit, an attribute of a group to each of the plurality of axes by the input unit, and the apparatus sort, when the system configuration of the plurality of axes is displayed in the list form on the output unit, the plurality of axes by each of the numbers or the groups according to a command from the input unit.

### FIELD

The present invention relates to a setting/adjustment function in a multi-axis control system, and particularly to a multi-axis control system setting/adjustment function supporting apparatus that supports to realize a system configuration setting function, a parameter setting function, a monitor function, and a test function for the multi-axis control system.

### BACKGROUND

It is described in Patent Literature 1 that a plurality of axes are logically grouped together and defined. It is described in Patent Literature 2 that a plurality of axes are grouped together into several axis groups, and a parameter is set to each of the axis groups.

It is described in Patent Literature 3 that a servo parameter that is an adjustment result of one axis is also applied to another axis, thereby setting the same servo parameter to a plurality of axes.

It is described in Patent Literature 4 that information is displayed by switching between a specific axis group, a plurality of axis groups, and all axes.

It is described in Patent Literature 5 that axes that execute a synchronization control are set, and a command to be provided to an arbitrary axis among the axes is copied and provided to the other axes, thereby providing the same command to all the axes.

### CITATION LIST

### Patent Literatures

Patent Literature 1: Japanese Patent Application Laid-open No. H11-231915

Patent Literature 2: Japanese Patent Application Laid-open No. H10-187210

Patent Literature 3: Japanese Patent Application Laid-open No. 2007-172156

Patent Literature 4: Japanese Patent Application Laid-open No. 2000-330615

Patent Literature 5: Japanese Patent Application Laid-open No. 2005-50096

### SUMMARY

### Technical Problem

Conventional system configuration setting functions including those described in Patent Literatures 1 and 2 can group a plurality of axes together, thereby confirming the relevancy between the axes. However, there is a problem that when many axes are set, it is difficult to understand the entire system configuration, and therefore it takes time and labor in setting and adjustment.

Even when a synchronization control for performing the same operation is set to a plurality of axes, a conventional parameter setting function needs to set servo data, a servo parameter, and a synchronization parameter to each of the axes and repeat the setting by the number of the axes.

A conventional monitor function can display monitor information by switching between all axes, an arbitrary axis, and an arbitrary axis group. However, there is a problem that when the monitor information of all axes is displayed, it is difficult to understand the entire system configuration, and therefore it takes time and labor in setting and adjustment.

When a plurality of axes that simultaneously execute a test operation are designated, a conventional test function needs to designate each of the axes. Therefore, it is necessary to check whether servo data and a servo parameter are appropriate between the axes before executing the test operation.

The present invention has been achieved to solve the above problems, and an object of the present invention is to provide a multi-axis control system setting/adjustment function supporting apparatus that supports a system configuration setting function, a parameter setting function, a monitor function, and a test function for a multi-axis control system that executes a positioning control by synchronizing a plurality of axes, and that is capable of reducing time and labor in setting and adjustment.

### Solution to Problem

There is provided a multi-axis control system setting/adjustment function supporting apparatus having a setting/adjustment function through an input unit and an output unit for a multi-axis control system that includes a plurality of axes, each of the plurality of axes being a combination of one servo amplifier and one servo motor, the multi-axis control system executing a positioning control by synchronizing the plurality of axes according to a command from a motion controller, wherein the apparatus set, for a system configuration of the plurality of axes provided with respective numbers displayed in a list form on the output unit, an attribute of a group to each of the plurality of axes by the input unit, and the apparatus sort, when the system configuration of the plurality of axes is displayed in the list form on the output unit, the plurality of axes by each of the numbers or the groups according to a command from the input unit.

### Advantageous Effects of Invention

In the multi-axis control system setting/adjustment function supporting apparatus according to the present invention, a system configuration of axes is displayed in a form of a list to sort the list by each axis group, thereby easily understanding the entire system configuration, and a plurality of axis groups are further grouped together to hierarchize the axis groups, thereby easily understanding the system configuration even when many axes are set.

### BRIEF DESCRIPTION OF DRAWINGS

FIG. 1 is an example of a configuration diagram of a multi-axis control system and a multi-axis control system setting/adjustment function supporting apparatus according to an embodiment of the present invention.

FIG. 2 is an example of a system configuration setting screen according to the embodiment, in which axis groups are set, and the axis groups are hierarchized.

FIG. 3 is a flowchart of a process for setting a parameter to each axis group according to the embodiment.

FIG. 4 is an example of a monitor function screen according to the embodiment when axis groups are set.

FIG. 5 is an example of a “JOG OPERATION” screen according to the embodiment, in which a plurality of axes are designated as an execution axis.

FIG. 6 is an example of a “MANUAL PULSER OPERATION” screen according to the embodiment, in which a plurality of axes are designated as an execution axis.

FIG. 7 is an example of a “RETURN TO ORIGIN” screen according to the embodiment, in which a plurality of axes are designated as an execution axis.

FIG. 8 is an example of a screen that designates an “AXIS No.” of an axis that executes a test operation according to the embodiment.

FIG. 9 is an example of a screen that designates a “GROUP No.” of an axis that executes an A test operation according to the embodiment.

FIG. 10 is a flowchart of a process for executing a JOG operation after checking servo data and a servo parameter according to the embodiment.

### DESCRIPTION OF EMBODIMENTS

Exemplary embodiments of a multi-axis control system setting/adjustment function supporting apparatus according to the present invention will be explained below in detail with reference to the accompanying drawings. The present invention is not limited to the embodiments.

### Embodiment

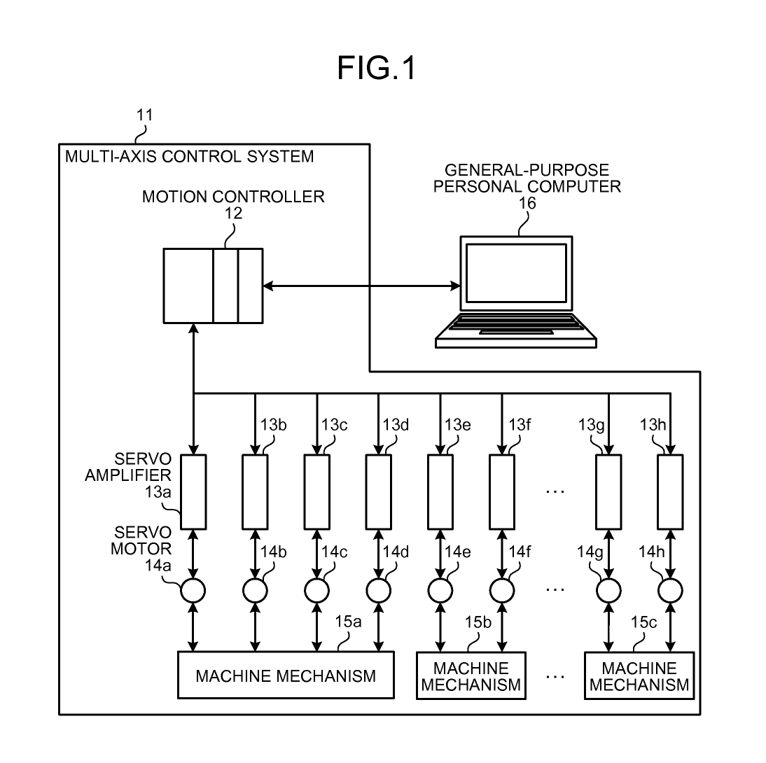

FIG. 1 is an example of a configuration diagram of a multi-axis control system that executes a positioning control by synchronizing a plurality of axes of a filling machine, a packing machine, a machine tool, or the like, and a multi-axis control system setting/adjustment function supporting apparatus according to an embodiment of the present invention. A multi-axis control system 11 is configured to include a motion controller 12, servo amplifiers 13a to 13h, servo motors 14a to 14h, and machine mechanisms 15a to 15c. A general-purpose personal computer 16 is connected to the motion controller 12. A system configuration and a parameter are set by the general-purpose personal computer 16, and written to the motion controller 12. A monitor function is used in the general-purpose personal computer 16 to read monitor information from the motion controller 12. A test function is used in the general-purpose personal computer 16 to transmit a command to the motion controller 12. In the present embodiment, the general-purpose personal computer 16 functions as a multi-axis control system setting/adjustment function supporting apparatus (an engineering tool) that executes the functions described above and a function to be explained below through an input unit (such as a keyboard and a mouse) and an output unit (such as a display).

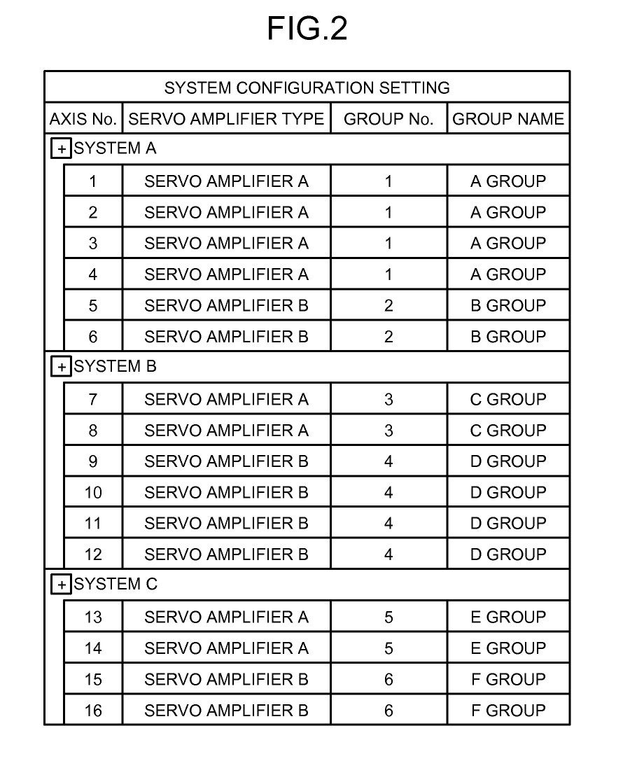

FIG. 2 is an example of a system configuration setting screen according to the present embodiment, in which axis groups including a plurality of axes are set, and a plurality of axis groups are further grouped together to hierarchize these axis groups. The system configuration setting screen is displayed on a display (an output unit) of the general-purpose personal computer 16, for example. On the system configuration setting screen, a system configuration of axes is displayed in a form of a list by an operation through the input unit of the general-purpose personal computer 16, and the list can be sorted in the order of the “AXIS No.” by clicking an “AXIS No.” display field, and also can be sorted in the order of the “GROUP No.” by clicking a “GROUP No.” display field. The “AXIS No.” is a number provided to each axis. The “AXIS No.”, “servo amplifier type”, “GROUP No.”, and “group name” are set to each axis through the input unit. In an example in FIG. 2, axes 1 to 4 are grouped together by setting the “GROUP No.” to “1” and setting the “group name” to “A group”, and axes 5 and 6 are grouped together by setting the “GROUP No.” to “2” and setting the “group name” to “B group”. The “GROUP No.” and the “group name” are attributes of a group (hereinafter, also “axis group”). A plurality of axes can be grouped together by setting the same “GROUP No.” and “group name” to the axes. The group 1 (an axis group in which the “GROUP No.” is “1”, that is, the A group) and the group 2 (an axis group in which the “GROUP No.” is “2”, that is, the B group) are further grouped together to set a name “system A” that is a higher attribute to the hierarchized axis group. Similarly, axis groups that are a group 3 and a group 4 are further grouped together to set a higher attribute “system B”, and axis groups that are a group 5 and a group 6 are further grouped together to set a higher attribute “system C”. In the hierarchized axis groups described above, each system that is a higher attribute and includes a plurality of axis groups can be switched between display and non-display in a collapsible manner.

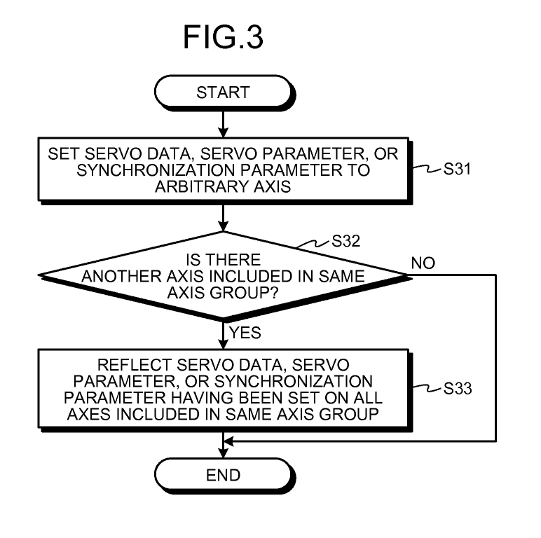

FIG. 3 is a flowchart of a process for setting a parameter to each axis group according to the present embodiment. Contents of each step are described below in detail.

A servo set value, required to execute a positioning control, is referred to as “servo data”. A characteristic value of a servo amplifier, required for a servo operation, is referred to as “servo parameter”. A set value, required to realize a synchronization control by software in place of machine mechanisms such as a gear, a shaft, a transmission, and a cam, is referred to as “synchronization parameter”. First at Step S31, a predetermined value is set to an arbitrary axis as servo data, a servo parameter, or a synchronization parameter.

Next, at Step S32, whether there is an axis included in the same axis group as the axis to which a parameter has been set at Step S31 is determined. When there is the axis as described above (YES at Step S32), the process advances to Step S33. When there is not the axis as described above (NO at Step S32), the process is ended.

Finally, at Step S33, the predetermined value, having been set as servo data, a servo parameter, or a synchronization parameter at Step S31, is reflected on all the axes included in the same axis group as the axis to which a parameter (servo data, a servo parameter, or a synchronization parameter) has been set at Step S31 (however, the predetermined value is automatically reflected without need of any special operation). That is, the same set value of a parameter (servo data, a servo parameter, or a synchronization parameter) is given to axes in the same axis group.

As described above, it is possible to group a plurality of axes, to which a synchronization control for performing the same operation is set, together into an axis group, set servo data, a servo parameter, and a synchronization parameter of an arbitrary axis included in the axis group, and simultaneously reflect the same parameter on all the axes included in the same axis group as the arbitrary axis, thereby setting a parameter to each axis group, and saving the labor in repeating parameter setting by the number of the axes.

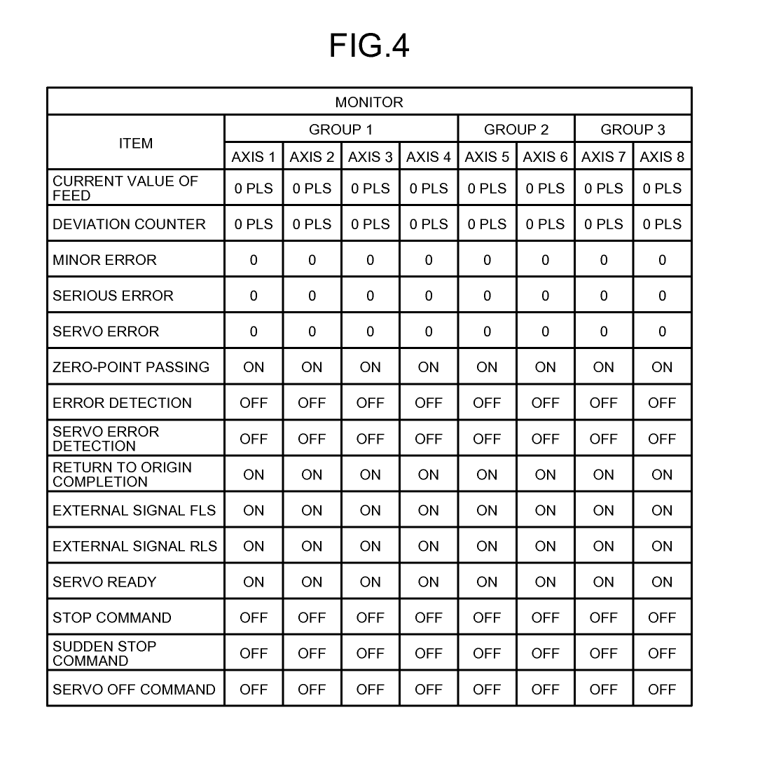

FIG. 4 is an example of a monitor function screen when axis groups are set in the same manner as an example of the system configuration setting screen in FIG. 2. On the monitor function screen, monitor information can be displayed by switching between all axes, an arbitrary axis, and an arbitrary axis group. In the example in FIG. 4, the groups 1 to 3 (the axes 1 to 8) are displayed. When monitor information of all axes is displayed, the monitor information can be rearranged by dragging and dropping the “AXIS No.” display field or the “GROUP No.” display field. When a data display field of each monitor item is selected, and the monitor item is about a bit device, the bit device can be ON or OFF, or ON/OFF can be reversed, to each axis or each axis group through a right click menu. When the monitor item is about a word device, arbitrary data can be written in the data display field. Each monitor item can be set in a digital oscilloscope probe to a desired axis or each axis group through the right click menu by selecting the data display field of the monitor item.

As described above, axis groups are set according to a system configuration, monitor information is displayed by switching between all axes, an arbitrary axis, and an arbitrary axis group, and the monitor information of all axes is sorted by each axis group and displayed. Therefore, the entire system configuration can be easily understood. It is possible to set a bit device of each monitor item to ON or OFF, or reverse ON/OFF, to each axis or each axis group, write arbitrary data to a word device of each monitor item, and set each monitor item in a digital oscilloscope probe to each axis or each axis group, thereby improving adjustment work efficiency.

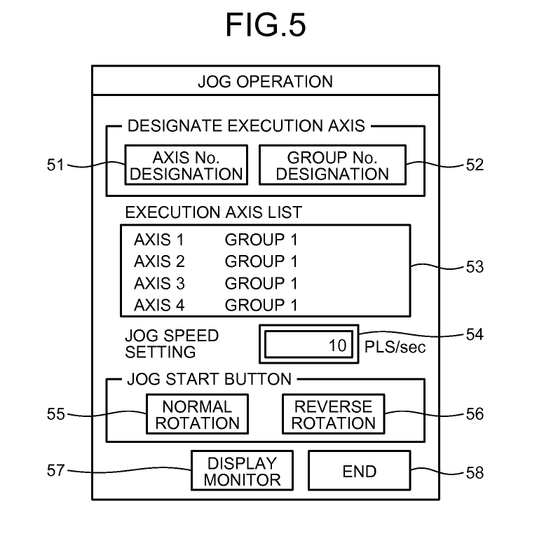

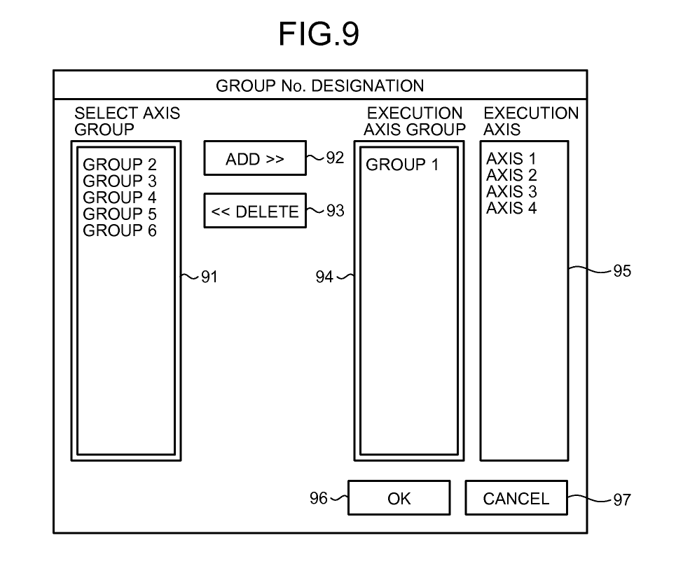

FIG. 5 is an example of a “JOG OPERATION” screen according to the present embodiment, in which a plurality of axes are designated as an execution axis. On the “JOG OPERATION” screen, by using the input unit (such as a keyboard and a mouse), a “AXIS No. DESIGNATION” button 51 is pressed to start an “AXIS No. DESIGNATION” screen in FIG. 8, or a “GROUP No. DESIGNATION” button 52 is pressed to start a “GROUP No. DESIGNATION” screen in FIG. 9 in order to designate an axis that executes a JOG operation. The designated axis is displayed in an execution axis list 53. A speed to execute a JOG operation is input in a JOG-speed setting field 54 (however, the speed is supposed to be common to all the axes that execute a JOG operation). While a JOG normal-rotation button 55 is pressed, the JOG operation is executed in the normal direction, or while a JOG reverse-rotation button 56 is pressed, the JOG operation is executed in the reverse direction. A monitor display button 57 is pressed to start the monitor function screen in FIG. 4. An end button 58 is pressed to end the “JOG OPERATION” screen.

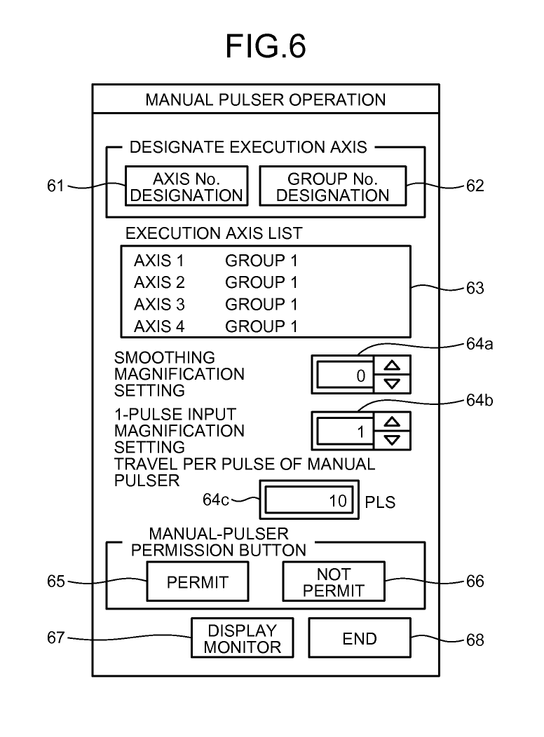

FIG. 6 is an example of a “MANUAL PULSER OPERATION” screen according to the present embodiment, in which a plurality of axes are designated as an execution axis. On the “MANUAL PULSER OPERATION” screen, by using the input unit, an “AXIS No. DESIGNATION” button 61 is pressed to start the “AXIS No. DESIGNATION” screen in FIG. 8, or a “GROUP No. DESIGNATION” button 62 is pressed to start the “GROUP No. DESIGNATION” screen in FIG. 9 in order to designate an axis that executes a manual pulser operation. The designated axis is displayed in an execution axis list 63. As manual pulser setting, a value is input in a smoothing-magnification setting field 64a, a 1-pulse input magnification setting field 64b, and a setting field 64c of a travel per pulse of the manual pulser (the value is common to all the axes that execute a manual pulser operation). A manual-pulser permission button 65 is pressed to permit the manual pulser operation to be executed. A manual pulser non-permission button 66 is pressed not to permit the manual pulser operation to be executed. A monitor display button 67 is pressed to start the monitor function screen in FIG. 4. An end button 68 is pressed to end the “MANUAL PULSER OPERATION” screen.

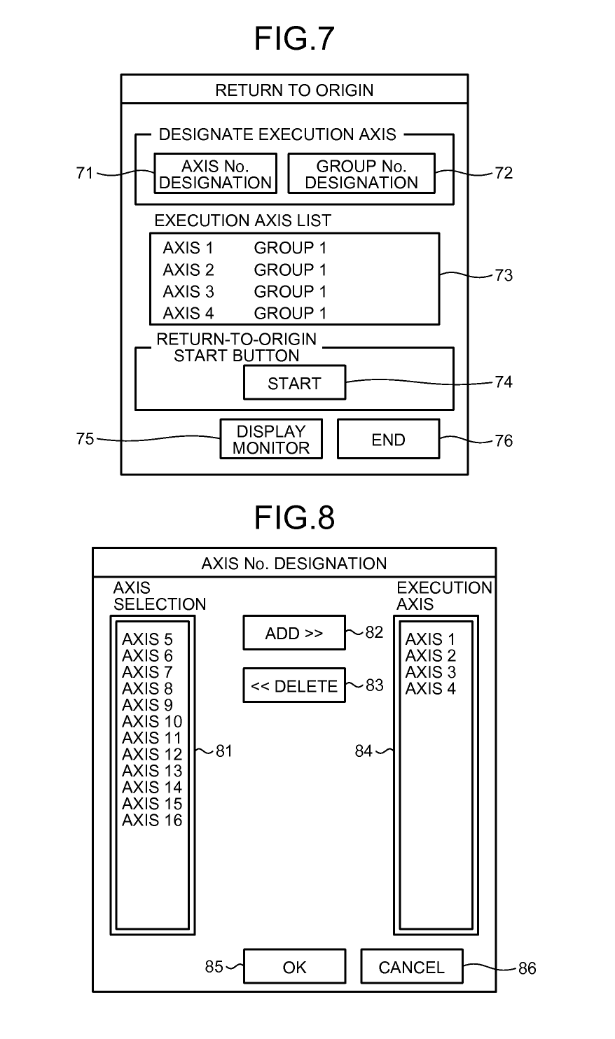

FIG. 7 is an example of a “RETURN TO ORIGIN” screen according to the present embodiment, in which a plurality of axes are designated as an execution axis. On the “RETURN TO ORIGIN” screen, by using the input unit, an “AXIS No. DESIGNATION” button 71 is pressed to start the “AXIS No. DESIGNATION” screen in FIG. 8, or a “GROUP No. DESIGNATION” button 72 is pressed to start the “GROUP No. DESIGNATION” screen in FIG. 9 in order to designate an axis that executes a return to origin. The designated axis is displayed in an execution axis list 73. A return-to-origin start button 74 is pressed to execute a return to origin. A monitor display button 75 is pressed to start the monitor function screen in FIG. 4. An end button 76 is pressed to end the “RETURN TO ORIGIN” screen.

FIG. 8 is an example of an “AXIS No. DESIGNATION” screen that designates the “AXIS No.” of an axis that executes a test operation such as a JOG operation, a manual pulser operation, and a return to origin according to the present embodiment. An axis that executes a test operation is selected from an axis selection field 81, and an addition button 82 is pressed to register the axis in an execution axis field 84. The registered axis is selected from the execution axis field 84, and a deletion button 83 is pressed to clear the registered axis. An OK button 85 is pressed to confirm setting contents in the execution axis field 84. A cancel button 86 is pressed to cancel the setting contents in the execution axis field 84.

FIG. 9 is an example of a “GROUP No. DESIGNATION” screen that designates the “GROUP No.” of an axis that executes a test operation such as a JOG operation, a manual pulser operation, and a return to origin. An axis group that executes a test operation is selected from an axis group selection field 91, and an addition button 92 is pressed to register the axis group in an execution axis group field 94. All axes included in the execution axis group are displayed in an execution axis field 95. The registered axis group is selected from the execution axis field 94, and a deletion button 93 is pressed to clear the registered axis group. An OK button 96 is pressed to confirm setting contents in the execution axis group field 94. A cancel button 97 is pressed to cancel the setting contents in the execution axis group field 94.

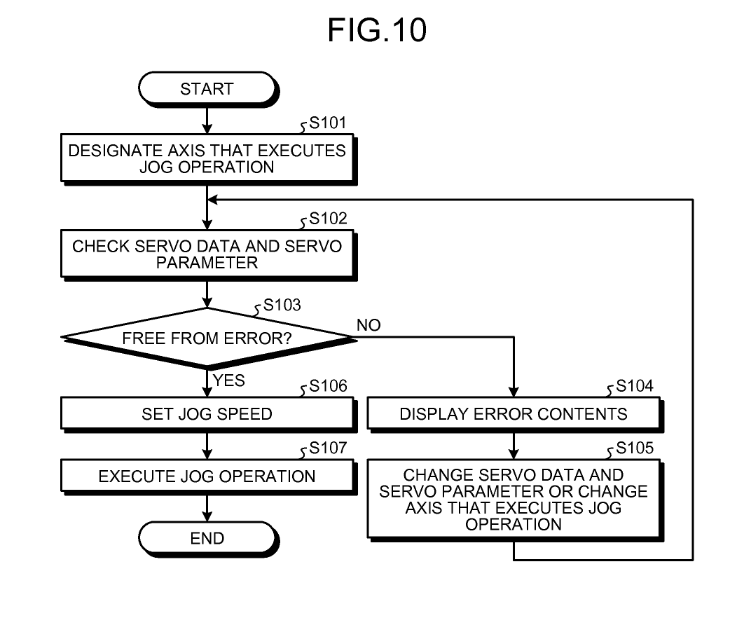

As an example of a process for executing a test operation, FIG. 10 is a flowchart of a process for executing a JOG operation after checking servo data and a servo parameter according to the present embodiment. Contents of each step are described below in detail.

First at Step S101, on a screen that designates an axis that executes a test operation in FIG. 8 or FIG. 9, an axis that executes a JOG operation is designated.

Next at Step S102, whether servo data and a servo parameter of all axes that execute a test operation are appropriate between the axes is checked.

Next at Step S103, whether check results at Step S102 are free from an error is determined. When check results are free from an error (YES at Step S103), the process advances to Step S106. When check results are not free from an error (NO at Step S103), the process advances to Step S104.

At Step S104, contents of the error in the check results of the servo data and the servo parameter are displayed.

Next at Step S105, according to the contents of the error displayed at Step S104, the servo data and the servo parameter are changed, or the axis that executes a JOG operation is changed. The process from Step S101 to S105 is the same as that in a manual pulser operation and a return to origin. Thereafter, the process shifts again to Step S102.

At Step S106, a JOG speed is set on the “JOG OPERATION” screen in FIG. 5.

Next at Step S107, a JOG normal-rotation button or a JOG reverse-rotation button is pressed on the “JOG OPERATION” screen in FIG. 5 to execute a JOG operation. Monitor information of the axis that has executed a test operation in this manner is displayed on the monitor function screen shown in FIG. 4.

As described above, a plurality of axes to be used in the same machine mechanism are grouped together and designated as an axis that executes a test operation. Therefore, a test operation of this machine mechanism can be executed. By checking whether servo data and a servo parameter are appropriate between the axes before executing a test operation, the machine mechanism can be confirmed not to operate in an unexpected manner. Monitor information of an axis that executes a test operation is displayed on an output unit of the multi-axis control system setting/adjustment function supporting apparatus, that is, a display of the general-purpose personal computer 16. Therefore, adjustment work efficiency can be improved through cooperation with the monitor function.

As explained above, in the multi-axis control system setting/adjustment function supporting apparatus according to the present embodiment, a system configuration setting function displays the type of a servo amplifier and a servo motor which are controlled by a motion controller, and the number of axes. A parameter setting function sets servo data, a servo parameter, and a synchronization parameter to each axis. A monitor function displays a list of monitor information of all axes or a selected axis. A test function executes a test operation such as a JOG operation, a manual pulser operation, and a return to origin to each axis. Further, in the multi-axis control system setting/adjustment function supporting apparatus according to the present embodiment, a plurality of axis groups are further grouped together, thereby hierarchizing the axis groups. Those contents are described in the embodiment.

Furthermore, in the multi-axis control system setting/adjustment function supporting apparatus according to the present embodiment, a system configuration of axes is displayed in a list to sort the list by each axis group. Furthermore, in the multi-axis control system setting/adjustment function supporting apparatus according to the present embodiment, a parameter including not only a servo parameter, but also servo data and a synchronization parameter is set to an arbitrary axis included in an axis group, thereby reflecting the same parameter on all the axes included in the same axis group as the arbitrary axis. Those contents are described in the embodiment.

Furthermore, in the multi-axis control system setting/adjustment function supporting apparatus according to the present embodiment, monitor information of all axes is sorted by each axis group and displayed. Furthermore, in the multi-axis control system setting/adjustment function supporting apparatus according to the present embodiment, an axis that executes a test operation is designated by the axis or by the axis group, thereby simultaneously executing a test operation by a plurality of axes, and checking whether servo data and a servo parameter are appropriate between the axes before executing the test operation. Those contents are described in the embodiment.

That is, in the multi-axis control system, an axis group including a plurality of axes is set, and a plurality of axis groups are further grouped together to hierarchize the axis groups, thereby easily understanding a system configuration even when many axes are set. A parameter is set to each of the axis groups, thereby saving the labor in repeating parameter setting by the number of the axes. A device operation of a monitor item, cooperation between a monitor function and a digital oscilloscope function, a test operation by each axis group, cooperation between a test function and the monitor function, and the like are possible, thereby improving adjustment work efficiency.

The invention of the present application is not limited to the above embodiment, and when the present invention is carried out, the invention can be variously modified without departing from the scope thereof. In the above embodiment, inventions of various stages are included, and various inventions can be extracted by appropriately combining a plurality of constituent elements disclosed herein. For example, even when some constituent elements are omitted from all constituent elements described in the embodiment, as far as the problems mentioned in the section of Solution to Problem can be solved and effects mentioned in the section of Advantageous Effects of Invention are obtained, the configuration from which these constituent elements have been omitted can be extracted as an invention. Furthermore, constituent elements common to different embodiments can be appropriately combined.

### INDUSTRIAL APPLICABILITY

As described above, the multi-axis control system setting/adjustment function supporting apparatus according to the present embodiment is useful to support to realize a system configuration setting function, a parameter setting function, a monitor function, and a test function for a multi-axis control system that executes a positioning control by synchronizing a plurality of axes of a filling machine, a packing machine, machine tool, or the like, and the apparatus is particularly suitable for realizing an efficient setting/adjustment work for a multi-axis control system.

### REFERENCE SIGNS LIST

11 multi-axis control system, 12 motion controller, 13a to 13h servo amplifier, 14a to 14h servo motor, 15a, 15b, 15c machine mechanism, 16 general-purpose personal computer, 51, 61, 71 “AXIS No. DESIGNATION” button, 52, 62, 72 “GROUP No. DESIGNATION” button, 53, 63, 73 execution axis list, 54 JOG-speed setting field, 55 JOG normal-rotation button, 56 JOG reverse-rotation button, 57, 67, 75 monitor display button, 58, 68, 76 end button, 64a smoothing-magnification setting field, 64b 1-pulse input magnification setting field, 64c setting field of travel per pulse of manual pulser, 65 manual-pulser permission button, 66 manual pulser non-permission button, 74 return-to-origin start button, 81 axis selection field, 82, 92 addition button, 83, 93 deletion button, 84, 95 execution axis field, 85, OK button, 86, 97 cancel button, 91 axis group selection field, 94 execution axis group field.

1. A multi-axis control system setting/adjustment function supporting apparatus having a setting/adjustment function through an input unit and an output unit for a multi-axis control system that includes a plurality of axes, each of the plurality of axes being a combination of one servo amplifier and one servo motor, the multi-axis control system executing a positioning control by synchronizing the plurality of axes according to a command from a motion controller, wherein
the apparatus set, for a system configuration of the plurality of axes provided with respective numbers displayed in a list form on the output unit, an attribute of a group to each of the plurality of axes by the input unit, and
the apparatus sort, when the system configuration of the plurality of axes is displayed in the list form on the output unit, the plurality of axes by each of the numbers or the groups according to a command from the input unit.

2. The multi-axis control system setting/adjustment function supporting apparatus according to claim 1, wherein
the apparatus set a higher attribute to the groups by the input unit, and
the apparatus switches, according to a command from the input unit, between display state and non-display state of the groups for each of the higher attributes in a collapsible manner on the output unit.

3. The multi-axis control system setting/adjustment function supporting apparatus according to claim 1, wherein
when the apparatus set a set value of servo data, a servo parameter, or a synchronization parameter of an arbitrary axis among the plurality of axes through the input unit, the apparatus set a same set value as the arbitrary axis to servo data, a servo parameter, or a synchronization parameter of all axes other than the arbitrary axis to which the attribute is set.

4. The multi-axis control system setting/adjustment function supporting apparatus according to claim 1, wherein
the apparatus displays monitor information on the output unit by switching between all the plurality of axes, an arbitrary axis of the plurality of axes, and an arbitrary axis of the groups, according to a command from the input unit,
when the apparatus displays the monitor information of all the plurality of axes on the output unit, the apparatus sorts the monitor information by each of the plurality of axes or the groups according to a command from the input unit,
when the monitor information is about a bit device, the apparatus set the monitor information to ON or OFF to each of the plurality of axes or the groups according to a command from the input unit,
when the monitor information is about a word device, the apparatus writes arbitrary data to the monitor information according to a command from the input unit, and
the apparatus set the monitor information as a digital oscilloscope probe for a desired axis of the plurality of axes or each of the groups according to a command from the input unit.

5. The multi-axis control system setting/adjustment function supporting apparatus according to claim 1, wherein
the apparatus designates a group to which the axis that executes a test operation belongs according to a command from the input unit, the apparatus checks whether servo data and a servo parameter are appropriate between axes belonging to the designated group, and the apparatus changes the servo data, the servo parameter, or the axis when there is an error, and
the apparatus executes the test operation simultaneously by the axes when there is not the error.

6. The multi-axis control system setting/adjustment function supporting apparatus according to claim 5, wherein
the test operation is a JOG operation, a manual pulser operation, or a return to origin.
